(19) United States
(12) Patent Application Publication
(10) Pub. No.: US 2026/0054230 A1
(43) Pub. Date: Feb. 26, 2026

(54) CARBON MOLECULAR SIEVE MEMBRANES AND METHODS FOR USING THE SAME

(71) Applicant: Dow Global Technologies LLC, Midland, MI (US)

(72) Inventors: Junqiang Liu, Manvel, TX (US); Li Tang, Houston, TX (US)

(73) Assignee: Dow Global Technologies LLC, Midland, MI (US)

(21) Appl. No.: 19/103,412

(22) PCT Filed: Aug. 17, 2023
(86) PCT No.: PCT/US2023/072363

§ 371 Date: Feb. 12, 2025

Related U.S. Application Data
(60) Provisional application No. 63/399,017, filed on Aug. 18, 2022.

(51) Int. Cl. B01D 71/30; B01D 53/22; B01D 67/00

(52) U.S. Cl. CPC B01D 71/30; B01D 53/228; B01D 67/0006; B01D 67/0086; B01D 2256/24; B01D 2257/7022

(57) ABSTRACT

A method of manufacturing a carbon molecular sieve (CMS) membrane includes forming one or more hollow fibers, the one or more hollow fibers including a polyvinylidene chloride copolymer; exposing the one or more hollow fibers to a caustic solution, wherein the caustic solution includes a strong base and a solvent; applying a tension at opposite ends of the one or more hollow fibers, thereby maintaining the one or more hollow fibers in a straight shape; pretreating the one or more hollow fibers under the tension by heating at a first temperature of from 120° C. to 200° C. with air, an inert gas, or combinations thereof; pyrolyzing the one or more hollow fibers at a second temperature of from 500° C. to 1500° C. with inert gas; and bundling the one or more hollow fibers to form the CMS membrane.

### CROSS REFERENCE TO RELATED APPLICATION

This application claims priority to U.S. Provisional Application Ser. No. 63/399,017, filed Aug. 18, 2022, which is hereby incorporated by reference in its entirety.

### FIELD

The present invention relates to the field of gas separation using a carbon membrane. More particularly, it relates to methods of producing carbon membranes for the separation of gas, as well as methods for the separation of gases and in particular hydrogen from a gas mixture by passing the gas mixture through a carbon membrane of polyvinylidene chloride copolymer hollow fibers.

### BACKGROUND

Carbon molecular sieves (CMS) and CMS membranes have been used to separate gases. CMSs may be prepared from a variety of resins that are pyrolyzed at various temperatures and/or under various conditions. The pyrolysis reduces the resins to carbon, but maintains at least some porosity, in the form of micropores, in the pyrolyzed product. The CMSs thus formed may then be employed in conventional gas separations equipment employing adsorption of particular gases, such as packed beds, columns, and the like, where the micropore size determines which gas in a gas mixture is adsorbed and which is not. Adsorption and desorption techniques may be alternated to carry out the separation, according to, for example, conventional pressure swing or temperature swing adsorption methods. CMS membranes have also been used to separate gases by flowing gas mixtures through the CMS membranes.

However, there is a particular challenge in the art to prepare CMSs having micropores of the correct size(s) for certain particular separations. Since the use of CMSs to accomplish separation assumes that the micropores are at least as large as, or larger than, the specified molecule that will enter the micropores, it is necessary to know the “size” of the specified molecule.

One chosen material for preparing the CMS membranes has been polyvinylidene chloride. Polyvinylidine chloride (PVDC) copolymers have previously been pyrolyzed to form carbon molecular sieves, but they have tended to form larger pores. Lamond T. G., et al., “6 Å molecular sieve properties of SARAN-type carbons,” Carbon (1965) 3, 59-63. This article describes preparation of a CMS, from a polyvinylidene chloride (PVDC) copolymer, that rejects neopentane (6.0 Å) molecules, but adsorbs smaller molecules, such as, in non-limiting example, CO₂, butane, and iso-butane, non-selectively. In view of this the authors of that article concluded that their CMS had 6 Å micropores.

Another example is disclosed in T. A. Centeno., et al., “Molecular sieve gas separation membranes based on poly (vinylidene chloride-co-vinyl chloride),” Carbon (2000) 38, 1067-1073. This article describes preparation of a composite carbon membrane using the aforesaid material. The membrane is formed with a thin microporous carbon layer (thickness of 0.8 microns, micrometers, μm) obtained by pyrolysis of the polymeric film, supported over a macroporous carbon substrate (pore size 1 μm; macroporosity 30 percent, %). Single gas permeation experiments include helium (He), carbon dioxide (CO₂), oxygen (O₂), nitrogen (N₂), and methane (CH₄). Selectivities are described as particularly high for O₂/N₂ systems, i.e., a selectivity of about 14 at 25 degrees Celsius (0° C.). From this information it can be inferred that the micropore size falls somewhere in a range from the representative molecular diameter of 02 (3.46 A) to that of N₂ (3.64 A). This CMS membrane is prepared by pre-treating the supported film at 200° C., a temperature at which the PVDC copolymer precursor is melted before carbonization. The fact that melting is required means that the disclosed CMS structures cannot be prepared in unsupported forms.

In other research, including for example, Laredo G. C., Meneses E., Castillo J., Marroquin J. O., Jimeenez-Cruz F., “Adsorption equilibrium and kinetics of branched octane isomers on a polyvinylidene chloride-based carbon molecular sieve,” Energy Fuels (2008) 22 (4) 2641-2648, polyvinylidene chloride copolymer-based CMSs have been prepared that exhibit relatively large micropore sizes and pore volumes that are suitable for separation of correspondingly large molecules, i.e., those having a representative molecular diameter greater than 5.0 Å.

More recently, WO/2016/003680 described forming a CMS from PVDC copolymers using a two-step pyrolysis at high temperatures from 800° C. to 1700° C. The CMS formed had an average pore size in the range of 3 Å to 5 Å. These CMS were described as being useful for separating Propylene (C₃H₆) and propane (C₃H₈); carbon dioxide (CO₂) and nitrogen (N₂); N₂ and methane (CH₄); ethylene (C₂H₄) and ethane (C₂H₆); and n-butane (C₄H₁₀) and i-butane (C₄H₁₀).

### SUMMARY

Two problems associated with traditional processes for producing CMS membranes consistently having micropores of the correct size(s) for certain particular separations are sintering and fuzzing of the individual hollow fibers that make up the CMS membranes.

As used herein “sintering” or “fusion” refers to a phenomenon where the individual hollow fibers that make up the CMS membranes fuse to each other by softening and melting during the manufacture of the individual hollow fibers. This may occur during the process of heating the individual fibers, as substances such as PVDC are known to soften upon reaching temperatures at or above 150° C. The resulting fused fibers, as illustrated in FIG. 1, may be of varying micropore sizing, and may be rendered inoperable for gas separation by such fusion. Additionally, fused fibers may not make a homogenous CMS membrane, as adhesives that may be used to bundle the fibers together may not completely coat all outside surfaces of the fibers. The sintering of the fibers may also reduce the mechanical strength of the fibers, which may lead to shattering of the fibers during handling.

As used herein, “fuzzing” or “curving” refers to a phenomenon where the individual hollow fibers experience curvature during the manufacture of the individual hollow fibers. This phenomenon may give a bundle of the hollow fibers the appearance of being ‘fuzzy’ or not otherwise appearing as a bundle of straight tubes. As stated above, individual fibers are known to soften upon reaching temperatures at or above 150° C. Accordingly, the individual hollow fibers may warp or compress as the structure changes, changing the shape of the fibers and their micropore structure. The resulting fibers, as illustrated in FIG. 2, may experience significant curvature along their length. As previously stated, this may cause changes of the micropore sizing within the length of the fibers, potentially leading to capturing of larger gas molecules than intended, or more significantly, blocking of certain pore spaces by crimping, reducing the capturing/sieving ability in these area entirely. Further, the fuzzing may result in less hollow fibers being able to be packed together and result in non-ideal fluid flow, reducing the efficiency of the resulting CMS membranes.

Accordingly, it would be desirable to realize a CMS membrane and process to make the CMS membrane that would not encounter these fuzzing or sintering behaviors. The resultant CMS membrane would be of a consistent micropore sizing, allowing the separation of gases within a gas mixture based on the representative molecular diameter. This may include gas mixtures encountered in syngas, gases generated in oil refineries, natural gas and olefin cracker gas streams.

Accordingly, a method of manufacture is discussed herein that produces CMS membranes made up of hollow fibers without the previous problems. The present methods accomplish this through two primary features, exposing the hollow fibers to a caustic solution, and keeping the hollow fibers under tension while they are heated and thermally degrade. The exposure to the caustic solution generally prevents the individual hollow fibers from fusing, and the tension generally prevents the fuzzing of the hollow fibers. This may result in CMS membranes with improved separation qualities for gas mixtures without the fuzzing or sintering problems associated with other methods of manufacture.

According to one embodiment, a method of manufacturing a carbon molecular sieve (CMS) membrane includes forming one or more hollow fibers, the one or more hollow fibers including a polyvinylidene chloride copolymer; exposing the one or more hollow fibers to a caustic solution, wherein the caustic solution includes a strong base and a solvent; applying a tension at opposite ends of the one or more hollow fibers, thereby maintaining the one or more hollow fibers in a straight shape; pretreating the one or more hollow fibers under the tension by heating at a first temperature of from 120° C. to 200° C. with air, an inert gas, or combinations thereof; pyrolyzing the one or more hollow fibers at a second temperature of from 500° C. to 1500° C. with inert gas; and bundling the one or more hollow fibers to form the CMS membrane.

According to another embodiment, a process for separating gases from a gas mixture includes forming the CMS membrane according to any embodiment herein; and flowing the gas mixture through the CMS membrane to produce a permeate first stream having an increased concentration of the first gas molecules and a second retentate stream having an increased concentration of the second gas molecules, wherein the gas mixture includes first gas molecules and second gas molecules, and the first gas molecules have a lesser representative molecular diameter than the second gas molecules.

Additional features and advantages of the embodiments described herein will be set forth in the detailed description which follows, and in part will be readily apparent to those skilled in the art from that description or recognized by practicing the embodiments described, including the detailed description and the claims which are provided infra.

### BRIEF DESCRIPTION OF THE DRAWINGS

The following detailed description of specific embodiments of the present disclosure can be best understood when read in conjunction with the following drawings in which:

FIG. 1 is a scanning electron microscope (SEM) image of polyvinylidene chloride (PVDC) copolymer hollow fibers, with fusion (sintering);

FIG. 2 is an image of PVDC copolymer hollow fibers, with fuzzing (curving);

FIG. 3 is an image of PVDC copolymer hollow fibers prepared according to embodiments herein, without fuzzing;

FIG. 4 is an SEM image of PVDC copolymer hollow fibers prepared according to embodiments herein, without fusion;

FIG. 5 is an image of a carbon molecular sieve (CMS) membrane prepared according to embodiments herein;

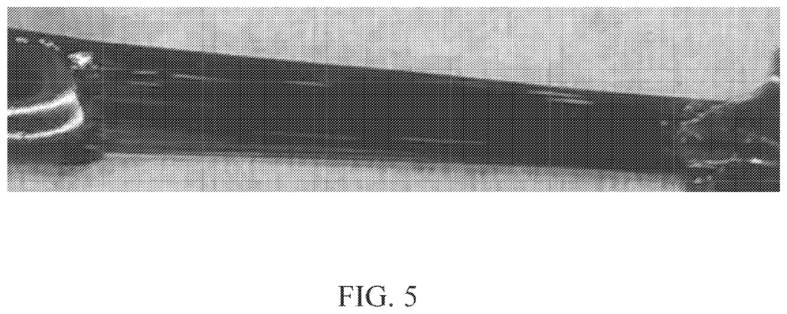

FIG. 6 is an image of PVDC copolymer hollow fibers prepared according to embodiments herein, without fuzzing or fusion; and

FIG. 7 is an image of a hollow fiber testing module, according to the Examples herein.

### DETAILED DESCRIPTION

Embodiments described herein relate to methods of manufacturing a carbon molecular sieve (CMS) membrane, as well as processes for utilizing the CMS membrane.

As used herein, “aqueous” may refer to a fluid containing, producing, resembling, or having the properties of water. As used herein, “non-aqueous” may refer to a fluid, not containing, producing, resembling, or having the properties of water.

As used herein, “dehydrochlorination” may refer to an elimination reaction which removes a hydrogen, chloride, or hydrogen halide from a substrate. For example, dehydrochlorination of polyvinylidene chloride may involve a 1,2 elimination involving an ion pair or a highly polarized four-center transition state. In another example dehydrochlorination involves the rearrangement at the chloroallyic structure into a cis-allyic configuration that subsequently loses HCl though a six-center concerted process.

Additional features and advantages of the described embodiments will be set forth in the detailed description, which follows, and in part will be readily apparent to those skilled in the art from that description or recognized by practicing the described embodiments, including the detailed description, which follows, as well as the claims.

The gas permeation properties of a membrane, such as the CMS membranes described in further detail herein, may be determined by gas permeation experiments. Two intrinsic properties have utility in evaluating separation performance of a membrane material: its “permeability,” a measure of the membrane's intrinsic productivity; and its “selectivity,” a measure of the membrane's separation efficiency. One typically determines “permeability” (Pᵢ) in Barrer

$$( 1 Barrer = {10}^{- 10} \frac{{cm}^{3} cm}{{cm}^{2} s cm Hg} )$$

calculated as the flux (nᵢ) divided by the partial pressure difference between the membrane upstream and downstream (Δpᵢ), and multiplied by the thickness of the membrane (1). In the embodiments herein, the thickness of the membrane may be generally expressed as the wall thickness, (OD-ID)*/2, of the hollow fibers (1):

$${P}_{i} = \frac{{n}_{i} * l}{Δ {p}_{i}}$$

Another term, “permeance,” is defined herein as productivity of the CMS membrane or individual hollow fiber and is typically measured in Gas Permeation Units (GPU)

$$( 1 G P U = {10}^{- 6} \frac{{cm}^{3}}{{cm}^{2} s c mH g} )$$

determined by dividing permeability by effective membrane separation layer thickness:

$$( \frac{{P}_{i}}{l} ) = \frac{{n}_{i}}{Δ {p}_{i}}$$

Finally, “selectivity” is defined herein as the ratio of one gas's permeability through the membrane or permeance relative to the same property of another gas. It is measured as a unitless ratio:

$${∝}_{i / j} = \frac{{P}_{i}}{{P}_{j}} = \frac{{P}_{i} / l}{{P}_{j} / l}$$

As previously stated, embodiments herein are directed to methods of manufacturing a carbon molecular sieve (CMS) membrane, as well as processes utilizing the CMS membranes. The method initially includes forming or obtaining one or more hollow fibers. In embodiments the one or more hollow fibers include a polyvinylidene chloride copolymer. The method then includes exposing the one or more hollow fibers to a caustic solution. The one or more hollow fibers are pretreated by heating at a first temperature; and then pyrolyzed at a second temperature. Finally, the one or more hollow fibers are bundled to form the CMS membrane.

In embodiments, forming the one or more hollow fibers may further include copolymerization of the vinylidene chloride copolymer with a comonomer to form the polyvinylidene chloride copolymer. The copolymerization method may include but is not be limited to, mass polymerization, suspension polymerization, or emulsion polymerization. It is generally preferred that copolymerization is carried out at a temperature that ensures avoidance of thermal degradation of all of the PVDC components such as from 10 to 120° C., from 20 to 100° C., or from 30 to 90° C.

Following the copolymerization, the polyvinylidene chloride copolymer may be formed into the one or more hollow fibers by any suitable method such as those known in the art. For example, the PVDC may be melt-extruded or solution spun in order to form the PVDC into a hollow fiber. Fibers may be produced by uniaxial stretching using known fiber processes for PVDC copolymers, and may be round or shaped hollow fibers, or of any other desired hollow fiber morphology. It is also contemplated that precursor films and/or fibers may be coextruded with multiple PVDC copolymers and/or with other polymers.

It is noted that the fiber preparation process may optionally include stretching, such as stretching of the resin to form a melt-extruded fiber. This stretching may, in particular embodiments, be particularly effective in inducing more rapid crystallization and in increasing, and therefore improving, alignment of the crystallites of the one or more hollow fibers. Desirably, the stretch ratio ranges from 1 to 8, such as from 1 to 6, from 1 to 4, and from 2 to 4.

Generally it is useful for the one or more hollow fibers to have some amount of crystallinity. In the present invention this crystallinity typically ranges from 25% to 75% of the resin or formed film, as measured by differential scanning calorimetry (DSC) according to ASTM D3418. In embodiments, this level ranges from 30% to 55%, or this level ranges from 35% to 50%. Thus, inclusion of a comonomer generally helps to reduce precursor crystallinity to ensure the desired range, and also to reduce the melt temperature and thereby improve processability of the resulting copolymer. In general, inclusion of bulkier monomers may tend to reduce overall copolymer crystallinity by a greater amount than inclusion of less bulky monomers. Thus, for example, butyl acrylate will tend to reduce crystallinity more than, for example, methyl acrylate or ethyl acrylate, assuming such is/are used in the same mole percent (mol %) based on final copolymer composition.

The polyvinylidene chloride may have the general Formula I, wherein n is an integer from 1 to 1000:

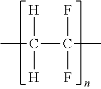

As previously stated, the polyvinylidene chloride copolymer may include vinylidene chloride and at least one of the following comonomers: a vinyl monomer, a vinyl chloride monomer, an acrylate monomer, a methacrylate monomer, a styrenic monomer, acrylonitrile, methacrylonitrile, itaconic acid, and pyrolyzed chlorotrifluoroethylene. The polyvinylidene chloride copolymer may include at least 60 wt. %, or alternatively at least 70 wt. %, vinylidene chloride, based on the total weight of the copolymer. The polyvinylidene chloride copolymer may include up to approximately 97 wt. % vinylidene chloride, and therefore the polyvinylidene chloride copolymer may include at least 3 wt. % of the comonomers previously stated in this paragraph. The polyvinylidene chloride copolymer may include from 3 to 40 wt. %, from 3 to 30 wt. %, or from 3 to 20 wt. % of the comonomer. The polyvinylidene chloride copolymer may also include from 3.5 to 15 wt. %, from 4 to 12 wt. %, from 7 to 28 wt. %, or from 9 to 25 wt. % comonomer.

The one or more hollow fibers may also include additional additives. The additives may include, but are not necessarily limited to, epoxidized oil stabilizers such as expoxidized soybean oil, expodized linseed oil, and the diglycidyl ether of bisphenol A. Also frequently employed are liquid plasticizers such as aliphatic and aromatic esters, including for example dibutyl sebacate, acetyl tributyl citrate, dioctyl phthalate, and the like, and combinations thereof. Other common additives may include lubricants, such as polyethylene wax, paraffin wax, oxidized polyethylene wax, and combinations thereof. Lubricants may optionally be included, and may include, for example, high density polyethylene, acrylate copolymers and silicone polymers, and combinations thereof. Another group of additives that may be included are acid scavengers such as epoxy compounds, magnesium hydroxide, magnesium oxide, tetrasodium pyrophosphate, calcium phosphate, magnesium phosphate, DHT 4A (a synthetic hydrotalcite-like halogen scavenger available from Kyowa Chemical Industry), calcium oxide, calcium carbonate, and combinations thereof. Antioxidants such as phenolics may also be incorporated. Combinations of any or all of these types of additives may be included in the one or more hollow fibers.

In embodiments, the total amount of all additives combined may be no more than 15 wt. %, such as no more than 8 wt. % or 3 wt. % of the one or more hollow fibers. In many applications, however, an amount of all additives combined of at least 2 wt. % may be typical, with use thereof therefore ranging from 2 wt. % to 8 wt. %, or from 2 wt. % to 3 wt. % of the one or more hollow fibers. Those skilled in the art will be aware of the use of such additives and their indications and contraindications without further direction herein.

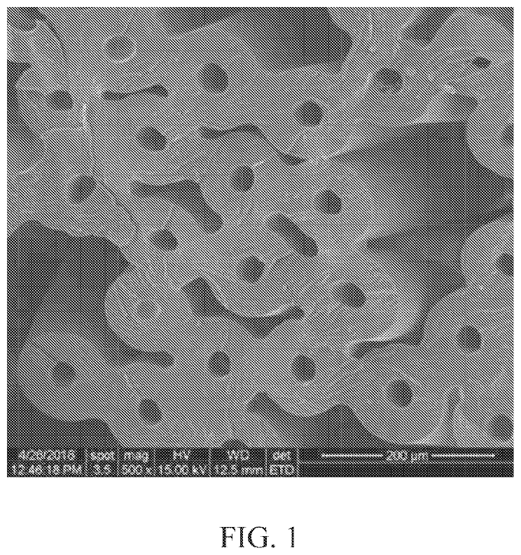

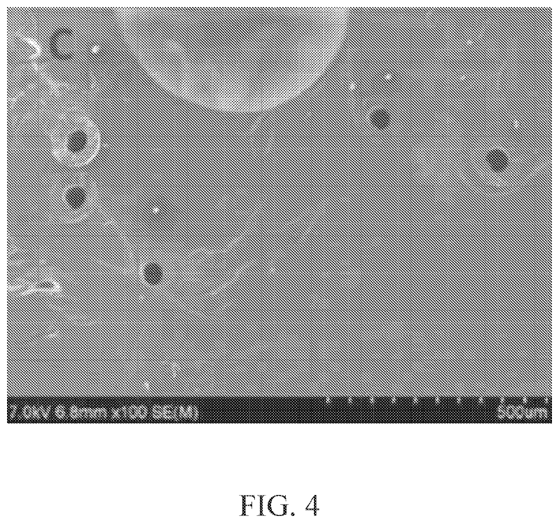

The one or more hollow fibers may each include an inner diameter and an outer diameter. The one or more hollow fiber may also include a length. In other words, the one or more hollow fibers may be regarded as tubes. This is shown for example in FIGS. 1 and 4. The outer diameter of the one or more hollow fibers may be from 50 microns (micrometers) to 5000 microns. The outer diameter may also be from any narrower range within the 50 to 5000 micron range. For example the one or more hollow fibers may have an outer diameter of from 50 to 100 microns, from 100 to 1000 microns, from 1000 to 2500 microns, from 2500 to 4000 microns, from 4000 to 5000 microns, or any combination of any of the end points of these ranges. The one or more hollow fibers may also have a thickness between the inner diameter and the outer diameter. The thickness may be from 10 microns to 100 microns. This is again shown, for example, in FIGS. 1 and 4. In FIG. 1, each of the hollow fibers, even while sintered, generally shows a thickness between the outer diameter and the inner diameter of hollow space. Similarly, FIG. 4 illustrates, especially on the middle left portion of the figure, similar thickness between the outer and inner diameter of the one or more hollow fibers. For example, the one or more hollow fibers may have an outer diameter of 50 microns with a thickness of 10 microns, such that the inner diameter is 30 microns. The one or more hollow fibers may alternatively have an outer diameter of 5000 microns with a thickness of 100 microns, such that the inner diameter is 4800 microns. In embodiments, the outer diameter and the thickness may be adjusted to change the inner diameter, by which flow rate possible through the CMS membrane is increased. Increasing the flow rate through the CMS membrane may also generally increase the amount of gas separated by the CMS membrane.

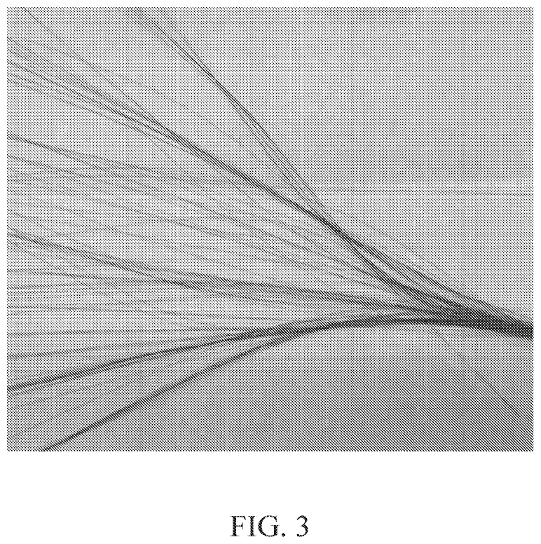

As previously stated, the method also includes exposing the one or more hollow fibers to a caustic solution. The caustic solution may include a strong base and a solvent. The strong base may include lithium hydroxide, sodium hydroxide, potassium hydroxide, rubidium hydroxide, cesium hydroxide, calcium hydroxide, strontium hydroxide, or combinations thereof. The strong base may also include organic amines. In embodiments, exposing the one or more hollow fibers to the caustic solution may cause a crosslinking reaction to occur on the surface of the individual hollow fibers. Exposure to the caustic solution may also cause dehydrochlorination of the surface of the individual hollow fibers. The rate of the crosslinking reaction, as well as the degree of resultant surface crosslinking, may be dependent on the strength and pH of the caustic solution used, as well as the amount of time the one or more hollow fibers remain exposed to the caustic solution. The surface crosslinking of individual hollow fibers may operate to prevent the individual hollow fibers from surface-to-surface softening and melting to other hollow fibers when the hollow fibers are later heated at the first temperature or second temperature. In other words, the surface crosslinking due to the exposure to the caustic solution may create a crosslinked surface layer on the individual hollow fibers, preventing the softening and melting from taking place between individual hollow fibers. This may in turn prevent the one or more hollow fibers from fusing or sintering together, ensuring a bundle of separated fibers, and thereby improving the permeance and selectivity of the resultant CMS membrane. This is illustrated for example in FIGS. 1, 3, and 4, as well as the Examples herein. FIG. 1 illustrates a bundle of hollow fibers that have not been exposed to a caustic solution before heating. FIG. 3 illustrates a bundle of hollow fibers that have been exposed to a caustic solution before heating. FIG. 4 illustrates a SEM image of the fusion free hollow fibers of FIG. 3 embedded in an epoxy matrix. Because the fibers are separated from each, the epoxy resin is better able to wet and fill the space between the hollow fibers. As shown in FIGS. 3 and 4, exposure to the caustic solution resulted in a reduction of fusing of the individual hollow fibers over FIG. 1.

It is contemplated that a weaker base, including but not limited to alanine, ammonia, methylamine, ammonium hydroxide, combinations thereof, or any other practical weaker base known to one in the art, may be used in the place of the strong base. However, it is further contemplated that should a weaker base be used, the one or more hollow fibers will need to remain exposed to the caustic solution for a greater period of time to allow the caustic solution to sufficiently crosslink the surface of the one or more hollow fibers. In other words, the presence of a weaker base may reduce the rate of the crosslinking reaction on the surface of the one or more hollow fibers.

The solvent may be an aqueous solution or a non-aqueous solution. The aqueous solution may be water. The water may be distilled water, deionized water, or tap water. The non-aqueous solution may be tetrahydrofuran, alcohols (such as but not limited to methanol), dimethylformamide, dimethyl sulfoxide, or combinations thereof. It is contemplated that non-aqueous solutions may be preferred as they may better coat the one or more hollow fibers with the strong base.

In embodiments, exposing the caustic solution to the one or more hollow fibers may include keeping the one or more hollow fibers completely submerged in the caustic solution over a longer period of time, or it may include dunking the one or more hollow fibers into the caustic solution over a shorter period of time. For example, and in embodiments, the one or more hollow fibers may be exposed to the caustic solution for one to ten seconds (shorter period), or from one to ten minutes (longer period). The caustic solution may also partly remain on the one or more hollow fibers after the one or more hollow fibers are removed from the caustic solution. The caustic solution may continue to operate to surface crosslink individual hollow fibers until the caustic solution is removed, or the caustic element driving the crosslinking reaction is used up.

As previously stated, the method further includes applying a tension to the one or more hollow fibers. In embodiments, the tension may be from 0.2 MPa to 2 MPa. The tension may also be from 0.01 to 0.5 MPa, from 0.01 to 1 MPa, from 0.01 to 2 MPa, from 0.01 to 5 MPa, from 0.01 to 10 MPa, from 0.2 to 2.0 MPa, from 0.5 to 1 MPa, from 0.5 to 5 MPa, from 0.5 to 10 MPa, from 1 to 5 MPa, or from 5 to 10 MPa, as well as any combination of the previous ranges or any smaller range therein. The tension may be applied at opposite ends of the one or more hollow fibers. The tension, in this manner, may be applied at the two open ends of the one or more hollow fibers, which may operate to maintain the relative shape of the one or more hollow fibers as a rod-like or tube-like structure, rather than as a sheet. In embodiments, it is contemplated that stretching the one or more hollow fibers into a sheet may render the one or more hollow fibers unusable for their primary purpose, namely, the preferential separation of two or more different kinds of gases. For example, stretching the hollow fibers into a sheet may close or otherwise disturb the central hollow opening in the one or more hollow fibers. The central hollow opening of which is attributable to the separation ability.

Applying the tension to the one or more hollow fibers may further include attaching an object of known weight to one end of the one or more hollow fibers. Applying the tension may further include hanging the object of known weight from the one or more hollow fibers, thereby applying the weight of the object along the length of the one or more hollow fibers as a tension. In embodiments, the one or more hollow fibers may be attached to the object of known weight through the use of a heat resistant adhesive, tying the one or more hollow fibers to the object of known weight, or combinations thereof. In embodiments, the systems used to apply the tension to the one or more hollow fibers may additionally be configured to perform the same function while withstanding the temperatures used in the pyrolyzing step. This may include using heat resistant components, such as but not limited to the use of the heat resistant adhesive.

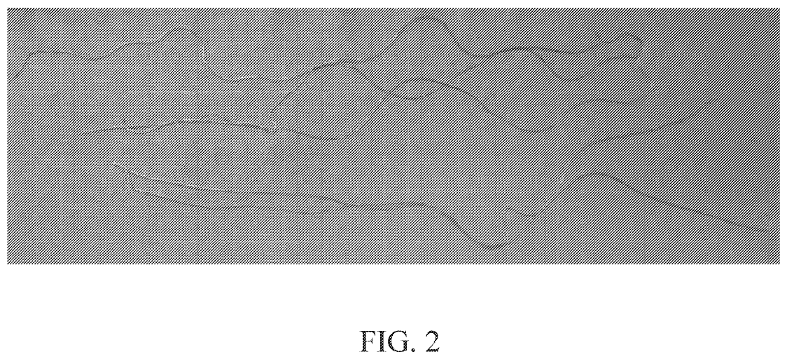

In embodiments, the tension may be applied at such an amount as to operate to maintain the one or more hollow fibers' length, the current curvature (or lack thereof), or both. Stated in another way, the tension may operate to maintain the current curvature by keeping the one or more hollow fibers straight. The tension may be applied at less than or equal to the yield strength of the one or more hollow fibers. As used herein, “yield strength” is the tensile strength above which the material experiences a specific amount of plastic deformation. Without begin bound by any particular theory, it is contemplated that applying tension at or just below the yield strength of the one or more hollow fibers may reduce the curvature that may be induced by later crosslinking and pyrolyzing of the one or more hollow fibers. This is illustrated for example, in FIGS. 2 and 3. FIG. 2 illustrates a bundle of hollow fibers that were not exposed to tension before heating. This bundle of hollow fibers shows significant fuzzing and curvature. This is contrasted with FIG. 3, which shows another bundle of hollow fibers that were subjected to the tension. This bundle of fibers shows very little fuzzing or curvature. As shown in the Examples herein, the lack of curvature may produce later benefits such as increased permeance or selectivity when the one or more hollow fibers are used in the CMS membrane to preferentially separate gas mixtures.

As previously stated, the method further includes pretreating the one or more hollow fibers under the tension by heating at a first temperature of from 120° C. to 200° C. with air, an inert gas, or both. In embodiments, the pretreatment of the one or more hollow fibers is used to stabilize, or “lock,” the copolymer structure prior to pyrolysis/carbonization thereof. In this step the one or more hollow fibers are generally heated below the melting temperature of the PVDC in order to dehydrochlorinate the fiber to the extent of at least 10%. As used herein, the term “at least 10% dehydrochlorinated” means that the hollow fiber has been pre-treated, by removing hydrogen chloride, to a point at which the PVDC copolymer hollow fiber no longer melts and, in fact, begins to become infusible. It is well-accepted in the art that such a change in molecular kinetics begins to occur at a point of approximately 10% dehydrochlorination and is completed or maintained as the level of dehydrochlorination increases above that point. In embodiments, this ‘locking’ of the copolymer structure may prevent further deformation or curvature in the pyrolysis step after pretreatment. Accordingly, if the shape of the one or more hollow fibers is maintained by the tension applied in the pretreating step, significant amounts of fuzzing of the one or more hollow fibers may not occur in the pyrolyzing step.

The first temperature may also be at any temperature range within 120° C. to 200° C. For example, the one or more hollow fibers may be heated at the first temperature of from 120 to 150° C., from 120 to 160° C., from 120 to 180° C., from 150 to 160° C., from 150 to 180° C., from 150 to 200° C., from 160 to 180° C., from 160 to 200° C., or from 180 to 200° C. In embodiments, heating at any of these temperatures may crosslink an interior of the one or more hollow fibers in addition to dehydrochlorination. As previously stated, exposing the one or more hollow fibers to the caustic solution before heating the one or more hollow fibers may also prevent the one or more hollow fibers from fusing to each other by creating a crosslinked surface layer on the one or more hollow fibers while pretreating by heating at the first temperature. Pretreating the one or more hollow fibers under the tension may further include contacting the one or more hollow fibers with the air, the inert gas, or both. Contacting the one or more hollow fibers with the air or the inert gas may occur at a rate sufficient to purge away the pretreatment gas products, such as methane, hydrogen, carbon monoxide, and carbon dioxide, thereby preventing secondary reactions of the dehydrochlorination gas products on the carbon surface. Contacting the one or more hollow fibers with the air or the inert gas in the pretreatment step may occur at a rate of approximately 2000 mL/min.

In embodiments, the pretreatment of the one or more hollow fibers may further include exposing the one or more hollow fibers to a source of high energy irradiation, such as gamma rays, an electron beam, ultraviolet light, or a combination thereof. The time may vary from 1 hour (hr) to 48 hr, preferably from 1 hr to 24 hr, and most preferably from 1 hr to 12 hr, as needed to reach the at least 10% dehydrochlorination point, at which the copolymer begins to become infusible, i.e., no longer able to be melted. The dehydrochlorination degree may vary from 5% to 100%, depending upon pretreatment temperature and time. Where more than visual confirmation of the beginning of infusibility is desired, additional confirmation of the percentage of dehydrochlorination may be obtained by means of, for example, Thermo Gravimetric Analysis (TGA), using standard and well-known methods and equipment.

As previously stated, the method further includes pyrolyzing the one or more hollow fibers at a second temperature of from 500° C. to 1500° C. with the inert gas. In embodiments, the pyrolysis may result in at least 90 wt. % of the copolymer becoming carbonized, more preferably at least 95 wt. %, and most preferably at least 99 wt. %. As already pointed out hereinabove, pyrolysis is also termed “carbonization,” because the result thereof is that the copolymer is converted to a carbon-only, or near carbon-only, skeleton of its copolymer structure, i.e., all or virtually all atoms other than carbon have been removed, but the carbon-carbon bonds remain substantially intact, and the one or more hollow fibers may now be termed to be “carbonaceous.” The pyrolysis may be carried out using any means generally known to those skilled in the art.

The second temperature may also be at any narrower temperature range within the 500 to 1500° C. For example, the one or more hollow fibers may be pyrolyzed at the second temperature of from 500 to 650° C., from 500 to 1000° C., from 500 to 1250° C., from 650 to 1000° C., from 650 to 1250° C., from 650 to 1500° C., from 1000 to 1250° C., from 1000 to 1500° C., or from 1250 to 1500° C. In embodiments, the inert gas may include carbon dioxide; nitrogen; any noble gas, including but not limited to argon; or combinations thereof. Pyrolyzing the one or more hollow fibers at the second temperature may further include contacting the one or more hollow fibers with the air, the inert gas, or both. Contacting the one or more hollow fibers with the air or the inert gas may occur at a rate sufficient to purge away the pyrolysis gas products, thereby preventing secondary reactions of the dehydrochlorination gas products on the carbon surface. Contacting the one or more hollow fibers with the inert gas in the pyrolysis step may occur at a rate of approximately 300 mL/min.

As previously stated, the method further includes bundling the one or more hollow fibers to form the CMS membrane. Bundling the one or more hollow fibers may include adding an adhesive to the one or more hollow fibers, thereby binding the hollow fibers together. Adding the adhesive may further include coating the exterior of the one or more hollow fibers with the adhesive and placing the one or more adhesive-coated hollow fibers in contact with one another. In embodiments, the adhesive may include epoxy, polyurethane, silicones, acrylics, or combinations thereof. The CMS membranes described herein may include from 1,000 to 10,000 of the one or more hollow fibers, as a bundle. The CMS membranes may also have an area of from 0.1 square meter to 10 square meters.

As stated above, the tension is applied to the one or more hollow fibers while they are pretreated. However, the tension may also be applied at any other step in the method. For example, and in embodiments, the tension may be applied while contemporaneously exposing the one or more hollow fibers to the caustic solution; while contemporaneously pyrolyzing the one or more hollow fibers; or both. The tension may also be applied during the bundling step, the drying step further discussed below, the water bath step, or any other step.

The method may also include drying the one or more hollow fibers. For example, and in embodiments, the hollow fibers may be dried before or after pretreating the one or more hollow fibers. The one or more hollow fibers may be dried by exposing the one or more fibers to the air, the inert gas, or both below 120° C., by wipe drying the one or more hollow fibers, or both. Drying the one or more hollow fibers may operate to remove the caustic solution from the one or more hollow fibers, thereby halting the surface crosslink reaction of the caustic solution with the one or more hollow fibers. In embodiments, the one or more hollow fibers may also be subjected to at least one water bath before drying or pretreating. The water bath may be composed of primarily water. The water bath may remove additional caustic solution from the one or more hollow fibers. This may be by dilution of the caustic solution in the case of an aqueous solvent, or by washing off in the case of the non-aqueous solvent.

As previously discussed, the CMS membranes may have a permeance, expressed as the permeability to flow a gas over the membrane layer thickness (individual hollow fiber wall thickness). However, the CMS membranes may have different permeances for different sized gases. As previously discussed, the ratio of these different permeances may be expressed as a selectivity for a given gas. For instance, the CMS membrane may selectively separate different gases from each other. As discussed in further detail below, this may allow the CMS membranes to act as a preferential separator of different sized gases. For example, and as shown in the Examples herein, the CMS membrane may have a propylene (C₃H₆) permeance of from 2 to 12 GPUs and a propane (C₃H₈) permeance of from 0.05 to 0.8 GPUs. Therefore, the CMS membrane may have a propylene/propane selectivity of from 12 to 54. This may allow the CMS membrane to preferentially separate the lighter propylene from the heavier propane. It is contemplated that this behavior may also extend to other olefin paraffin pairs, such that the CMS membrane may preferentially separate olefins from paraffins.

In embodiments, the CMS membrane may also have a propylene (C₃H₆) permeance of from 2 to 12 GPUs, from 2 to 11, from 2 to 8 from 2 to 5, from 2 to 3, from 2 to 2.5 GPUS, or any range therein, for example from 5 to 8 GPUs or from 2.5 to 11 GPUs. The CMS membrane may also have a propane (C₃H₈) permeance of from 0.05 to 0.8 GPUs, from 0.05 to 0.7, from 0.05 to 0.5, from 0.05 to 0.2, from 0.05 to 0.1, or any range therein, for example from 0.2 to 0.5 GPUS, or from 0.05 to 7 GPUs. The CMS membrane may also have a propylene/propane selectivity of any combination of the previous propylene and propane ranges, for example from 16 to 25, or any similar range therein between 12 to 54.

As stated above, embodiments herein are also directed to processes for separating gases from a gas mixture. The gas mixture includes first gas molecules and second gas molecules. The process includes forming a CMS membrane and flowing the gas mixture through the CMS membrane to produce a permeate first stream and a second retentate stream. The CMS membrane used in the process may be any of the CMS membranes previously discussed. The permeate first stream has an increased concentration of the first gas molecules than the second retentate stream, which in turn has an increased concentration of the second gas molecules than the permeate first stream. In this way, the CMS membrane used in the process may operate to separate the first gas molecules and the second gas molecules from each other.

As previously stated, determining the micropore/molecular sizing of the CMS membranes is important to determine the CMS membranes' suitability for particular separations. Different ways to determine the molecular size have been developed. One commonly employed approach has been to determine a given molecule's “kinetic diameter.” A reference listing a variety of these kinetic diameters, based upon their use in zeolite applications, is D. W. Breck, Zeolite Molecular Sieves: Structure, Chemistry and Use, John Wiley & Sons, Inc. (New York, N.Y. 1974), 636, and these determinations are frequently used even with respect to non-zeolite, carbon molecular sieves that are known to have slit-shaped pores. In view of the above and for purposes hereof, then, the following kinetic diameters, taken from the Breck reference cited supra, are used herein as the representative molecular diameters for the following molecules: He (2.6 Angstroms, Å), H₂ (2.89 Å), N₂ (3.64 Å), CO₂ (3.3 Å), CH₄ (3.8 Å), C₂H₄ (3.9 Å), CaH₈ (4.3 Å), i-C₄H₁₀ (5.0 Å), SF₆ (sulfur hexafluoride) (5.5 Å), and i-C₈H₁₈ (iso-octane) (6.2 Å). However, because that reference table lacks a kinetic diameter for ethane, and the kinetic diameter given therein for propylene is believed by at least some researchers to be inaccurate for CMS materials per se, the Lennard-Jones collision diameters are used herein, instead of the Breck kinetic diameters, for those two materials. These Lennard-Jones collision diameters are, respectively, C₂H₆ (4.1 Å), and C₃H₆ (4.0 Å). See, for example, Staudt-Bickel C., Koros W. J., “Olefin/paraffin gas separations with 61-DA-based polyimide membranes,” J. Membr. Sci. (2000) 170 (2), 205-214 for further discussion. The kinetic diameters and Lennard-Jones collision diameters are referred to together as “representative molecular diameters.”

In embodiments, the CMS membrane may have an average pore size greater than the second gas molecules' representative molecular diameter. The average pore size of the CMS membrane may be determined through gas adsorption techniques, employing gas probe molecules of differing sizes. The CMS membrane may have an average pore size of greater than 3 angstroms, greater than 4 angstroms, or greater than 5 angstroms. The CMS membrane may have an average pore size of at most approximately 15 angstroms. The CMS membrane may have an average pore size of from 2 to 15 angstroms, from 2 to 8, from 2 to 6, from 2 to 5, from 2 to 4, from 2 to 3, from 3 to 15, from 3 to 8, from 3 to 6, from 3 to 5, from 3 to 4, from 4 to 15, from 4 to 8, from 4 to 6, from 4 to 5, from 5 to 15, from 5 to 8, from 5 to 6, from 6 to 15, from 6 to 8, or from 8 to 15 angstroms. The average pore size may be determined by gas adsorption.

In addition to average micropore size, it is also often desirable in the art to optimize total micropore volume, which may be measured via the Brunauer-Emmett-Teller (BET) method at liquid N₂ temperature. Such may be further confirmed via helium (He) pycnometry and mercury (Hg) intrusion. For most separations applications, a total micropore volume of at least 0.10 mL/g, preferably at least 0.15 mL/g, more preferably at least 0.20 mL/g, according to the BET method at liquid N₂ temperature, may be needed to ensure commercially efficient desirable gas adsorption.

In embodiments, gas mixture may include olefins, paraffins, or both. The gas mixture may include at least two of carbon dioxide, nitrogen, carbon monoxide, methane, ethane, propane, ethylene, propylene, butane, or butylene. The first and second gas molecules may include any of the previous gases, as long as the second gas molecules have a greater representative molecular diameter than the first gas molecules. For example, if the first gas molecules are propylene, the second gas molecules may be propane, butane, or butylene, namely any gas molecule with a greater representative molecular diameter than propylene. In embodiments, the first gas molecules may include olefins and the second gas molecules may include paraffins. The first gas molecules may also include at least one of hydrogen, ethylene, propylene, or butylene, and the second gas molecules may include at least one of carbon dioxide, nitrogen, carbon monoxide, methane, ethane, propane, or butane.

### Examples

Hollow fibers, according to embodiments herein, were formed by melt extruding a PVDC copolymer of vinyl chloride. The properties of the hollow fibers were as follows in Table 1. All of the chemicals used in the Examples provided herein were obtained from Sigma Aldrich.

TABLE 1
Hollow Fiber Properties

| Property | Value |
|---|---|
| Outer Diameter (microns) | 164 |
| Inner Diameter (microns) | 76 |
| Wall thickness (microns) | 44 |
| Elastic Modulus (MPa) | 940 |
| Break Elongation (%) | 41 |

### Fabrication of CMS Membranes

CMS membranes were then formed from the hollow fibers according to embodiments herein. These CMS membranes were designated Examples 1-3. The resulting membranes were used in permeation testing, as described further below.

Example 1 was formed by submerging 40 hollow fibers in an aqueous-based caustic solution of 20 wt. % NaOH (200 grams) for 5 minutes. The hollow fibers were then allowed to air dry overnight at room temperature, 20° C. The hollow fibers were then subjected to a tension of 0.30 MPa by being pulled by 20 grams of weight. The hollow fibers were then pretreated by heating at 140° C. at a 1° C./min ramp from room temperature with 2 liters per minute of air purge. The hollow fibers were then washed using approximately 500 mL of a water bath at least 6 times to remove the residual caustic solution. The hollow fibers were then dried overnight at room temperature. Visual observation of the hollow fibers post-pretreatment did not show sintering or fuzzing of the hollow fibers, which, as previously discussed, is due to the caustic solution forming an already crosslinked surface layer on the hollow fibers before the pretreatment and the tension preventing curvature of the fibers during pretreating.

The hollow fibers were then threaded through alumina tubes with two internal bores (1 hollow fiber/alumina tube bore). The alumina tubes were obtained from McMASTER-CARR (product #87175k71, with outer diameter 0.0094 inches and inner diameter 0.025 inches, and were 9 inches long.) The hollow fibers were then pyrolyzed in a furnace at a peak temperature of 600° C., held for two hours, at a 3° C./min ramp from room temperature. A 300 ml/min flow of Argon purge was also used to keep the furnace free of oxygen. The resulting hollow fibers were free of both sintering and fuzzing.

Example 2 was formed by submerging 40 hollow fibers in an non-aqueous-based caustic solution of 45 wt. % KOH (200 grams), tetrahydrofuran (100 grams), and methanol (200 grams) for 10 minutes. The hollow fibers were then washed using approximately 500 mL of a water bath at least 6 times to remove the residual caustic. The hollow fibers were then allowed to air dry overnight at room temperature, 20° C. The hollow fibers were then subjected to a tension of 0.17 MPa by being pulled by 28 grams of weight. The hollow fibers were then pretreated for 24 hours by heating at 140° C. at a 1° C./min ramp from room temperature with 2 liters per minute of air purge. Then, hollow fibers were pretreated for an additional 12 hours by heating at 200° C. at a 1° C./min ramp from 140° C. with 2 liters per minute of air purge. Visual observation of the hollow fibers post-pretreatment did not show sintering or fuzzing of the hollow fibers, which, as previously discussed, is due to the caustic solution forming an already crosslinked surface layer on the hollow fibers before the pretreatment and the tension preventing curvature of the fibers during pretreating. The hollow fibers were then pyrolyzed in the same manner as Example 1. The resulting hollow fibers were free of both sintering and fuzzing.

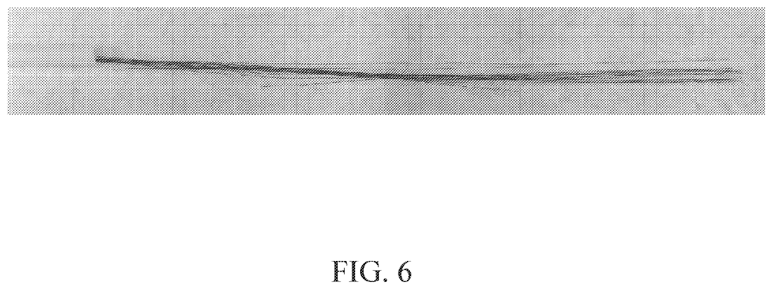

Example 3 was formed by submerging 200 hollow fibers in the non-aqueous-based caustic solution of Inventive Example 2 for 10 minutes. The hollow fibers were then washed using approximately 500 mL of a water bath at least 6 times to remove the residual caustic. The hollow fibers were then allowed to air dry overnight at room temperature, 20° C. The hollow fibers were then subjected to a tension of 0.06 MPa by being pulled by 20 grams of weight. The hollow fibers were then pretreated for 24 hours by heating at 140° C. at a 1° C./min ramp from room temperature with 2 liters per minute of air purge. Then, hollow fibers were pretreated for an additional 12 hours by heating at 170° C. at a 1° C./min ramp from 140° C. with 2 liters per minute of air purge. Visual observation of the hollow fibers post-pretreatment did not show sintering or fuzzing of the hollow fibers, which, as previously discussed, is due to the caustic solution forming an already crosslinked surface layer on the hollow fibers before the pretreatment and the tension preventing curvature of the fibers during pretreating. The hollow fibers were then pyrolyzed in the same manner as Example 1. The resulting hollow fibers were free of both sintering and fuzzing, as illustrated in FIG. 6.

### Fabrication of Comparative CMS Membranes

Additional CMS membranes were also manufactured from the hollow fibers for the purpose of comparison to the CMS membranes Examples reported above. These CMS membranes were designated Comparative Examples 1-4. The resulting membranes were used in permeation testing, as described further below.

Comparative Example 1 was formed by pretreating 100 hollow fibers by heating at 140° C. at a 1° C./min ramp from room temperature with 2 liters per minute of air purge and holding for 24 hours. The hollow fibers of Comparative Example 2 were not subjected to any tension. Visual observation of the hollow fibers post-pretreatment showed significant sintering and fuzzing of the hollow fibers. Particularly, almost all of the hollow fibers were fused together. Comparative Example 1 was not further pyrolyzed or subjected to permeation testing due to the observed fusion and fuzzing.

Comparative Example 2 was formed by pretreating 100 hollow fibers by heating at 140° C. at a 1° C./min ramp from room temperature with 2 liters per minute of air purge and holding for 24 hours. The hollow fibers of Comparative Example 2 were subjected to tension by pulling by 20 grams of weight. Visual observation of the hollow fibers post-pretreatment showed significant sintering of the hollow fibers. Particularly, similar to Comparative Example 1, almost all of the hollow fibers of Comparative Example 2 were fused together. Comparative Example 2 was not further pyrolyzed or subjected to permeation testing due to the observed fusion.

Comparative Example 3 was formed by pretreating 100 hollow fibers by heating at 140° C. at a 1° C./min ramp from room temperature with 2 liters per minute of air purge and holding for 24 hours. Each of the hollow fibers were separated in the alumina tubes. No tension was applied to the hollow fibers. The hollow fibers were then pyrolyzed according to Inventive Example 1. Visual observation of the hollow fibers post-pretreatment showed no sintering or fuzzing of the hollow fibers. However, this was to be expected as each of the fibers were not in contact with each other to possibly fuse, nor were they allowed to significantly curve due to being constrained within the alumina tubes.

However, even given the lack of sintering or fuzzing, it is contemplated that the method of manufacturing hollow fibers of Comparative Example 3 is not applicable to the generation of CMS membranes. Particularly, CMS membranes, as used in the processes herein, may include from 1,000 to 10,000 individual hollow fibers, as a bundle. In practical application, this would require the threading of thousands of individual fibers into individual alumina tubes in the pretreatment stage to avoid sintering of the fibers. The individual cost, both in time and economics, of such a method, especially when scaling up to an industrial manufacturing scale, would render the resultant CMS membranes economically unfeasible.

Comparative Example 4 was formed by submerging 200 hollow fibers in a caustic solution, according to the composition and method of Inventive Example 2. The hollow fibers were then washed also according to Inventive Example 2, then dried overnight at room temperature. Each of these hollow fibers were then threaded individually into the alumina tubes and pretreated according to Inventive Example 1. No tension was applied to the hollow fibers. The hollow fibers were then pyrolyzed according to Inventive Example 1. No sintering or fuzzing was observed in the fibers. However, like for Comparative Example 3, this was to be expected as all of the hollow fibers were not allowed to significantly curve due to being individually constrained within the alumina tubes. Additionally, similar to Comparative Example 3, the method of manufacturing hollow fibers of Comparative Example 4 is not applicable to the generation of CMS membranes. Particularly, Comparative Example 4 requires the threading of thousands of individual fibers into individual alumina tubes in the pretreatment stage to avoid fuzzing of the fibers. As previously stated, the individual cost, both in time and economics, of such a method, especially when scaling up to an industrial manufacturing scale, would render the resultant CMS membranes economically unfeasible.

A summary of the results of manufacturing the various hollow fibers is illustrated below in Table 2.

TABLE 2
Hollow Fiber Fabrication Summary

| Example | Caustic | Pretreatment | Tension | Pyrolysis | Observation |
|---|---|---|---|---|---|
| Inventive | 20 wt. % NaOH | 140° C. (24 hr) | 0.3 MPa, | In 0.025″ | Sintering and |
| Example 1 | solution, | | 40 fibers, | alumina tube | Fuzz Free Fibers |
| | 5 min dip | | 20 g weight | | |
| Inventive | 45 wt. % KOH, | 140° C. (24 hr) | 0.17 MPa, | In 0.025″ | Sintering and |
| Example 2 | methanol, | then 200° C. | 100 fibers, | alumina tube | Fuzz Free Fibers |
| | tetrahydrofuran, | (12 hr) | 28 g weight | | |
| | 10 min dip | | | | |
| Inventive | 45 wt. % KOH, | 140° C. (24 hr) | 0.06 MPa, | Bundle | Sintering and |
| Example 3 | methanol, | then 170° C. | 200 fibers, | pyrolysis | Fuzz Free Fibers |
| | tetrahydrofuran, | (12 hr) | 20 g weight | | |
| | 10 min dip | | | | |
| Comparative | None | 140° C. (24 hr) | None, | No | Sintered and |
| Example 1 | | | 100 fibers | | Fuzzed Fibers |
| Comparative | None | 140° C. (24 hr) | 0.12 MPa, | No | Sintered but |
| Example 2 | | | 100 fibers, | | Fuzz Free Fibers |
| | | | 20 g weight | | |
| Comparative | None | 140° C. (24 hr) | None, | In 0.025″ | Sintering and |
| Example 3 | | (in 0.025″ | 100 fibers | alumina tube | Fuzz Free Fibers |
| | | alumina tube) | | | |
| Comparative | 45 wt. % KOH, | 140° C. (24 hr) | None, | In 0.025″ | Sintering and |
| Example 4 | methanol, | (in 0.025″ | 200 fibers | alumina tube | Fuzz Free Fibers |
| | tetrahydrofuran, | alumina tube) | | | |
| | 10 min dip | | | | |

### Permeation Testing of CMS Membranes

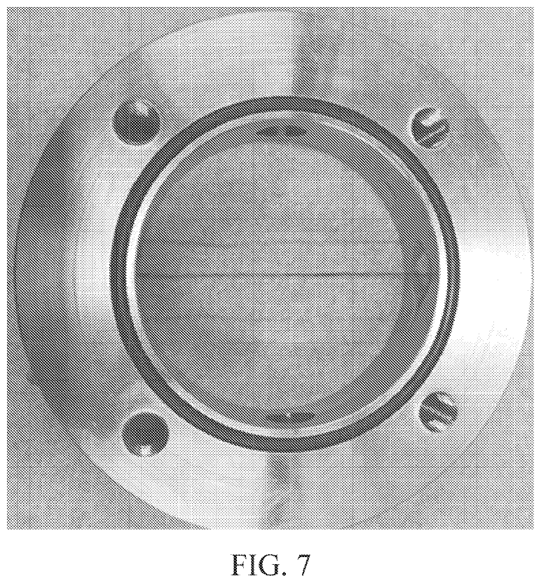

Each of the Examples and Comparative Examples were then tested for gas permeation, as well as gas selectivity. This was accomplished by building custom made ring permeation cells “modules.” As shown in FIG. 7, the ring cell has a five inch outer diameter, a three inch inner diameter, four half-inch wide openings on the wall with 9/16 inch o-ring fitting and quarter-inch thick covers at two side with the o-ring seal. The o-rings were provided by SAE/MS. Ten hollow fibers according to the Examples were then inserted into the half-inch wide openings on the wall of the ring cell, at approximately the 3 o'clock and 9 o'clock positions. A dam was made using Teflon tape around the fiber bundle inside the hole. An epoxy resin, (Scotch Weld DP100®) was used to fill the space around the hollow fiber hole and form a seal. This is illustrated for example by FIG. 4. Different hollow fibers were used for each module, according to the previously described Examples.

Mixed gas permeation testing at 35° C. was then conducted using the modules. A gas mixture of 50/50 propylene/propane was initially fed into the cell at a rate of 100 to 200 cm³/min. The gas mixture entered the module through the half-inch wide opening on the wall of the ring cell, at approximately the 12 o'clock position, passed through fiber bundle located orientated across the center of the module, and exited the module through the half-inch wide opening on the wall of the ring cell as a retentate (resulting) stream, at approximately the 6 o'clock position. The retentate stream was held at 52 psig (psi gage).

A continuous argon gas purge at 20 to 50 cm³/min was then used to carry the permeate stream (gas mixture trapped within the hollow fiber bundle) through the capillaries of the hollow fibers, from the 9 o'clock to the 3 o'clock position, to an area for Gas Chromatography (GC) analysis. The permeate flux was calculated using the argon purge flow rate and permeate gas concentration measured by the GC. The permeance was calculated as previously stated, by using the permeate flux, normalized by the total membrane area, which is the product of exposed fiber length, number of fibers, and the hollow fiber OD. As previously stated, the units for permeance are GPUs, measured as

$$1 G P U = {10}^{- 6} \frac{{cm}^{3}}{{cm}^{2} s cm Hg} .$$

The selectivity was determined by taking the ratio of propylene permeance divided by the propane permeance. The results of the permeation testing are shown below in Table 3. The age of the Examples reflects the number of days the Examples spent within a Nitrogen gas box between formation and testing within the modules. Table 4 below shows the average results of the modules based on the manufacture of the hollow fibers.

TABLE 3
Permeation Testing Results

| | Age Before | | Propylene | Propane | Propylene |
|---|---|---|---|---|---|
| | Test | | Permeance | Permeance | to Propane |
| Example | [days] | Module | [GPU] | [GPU] | Selectivity |
| Inventive | 5 | 1 | 6.3 | 0.2 | 31.3 |
| Example 1 | | | | | |
| Inventive | 7 | 1 | 9.8 | 0.8 | 12.4 |
| Example 2 | | | | | |
| Inventive | 15 | 2 | 11.7 | 0.52 | 22.4 |
| Example 2 | | | | | |
| Inventive | 15 | 1 | 5.8 | 0.12 | 49.0 |
| Example 3 | | | | | |
| Inventive | 15 | 2 | 2.4 | 0.05 | 53.4 |
| Example 3 | | | | | |
| Comparative | 8 | 1 | 13.6 | 0.45 | 30.3 |
| Example 3 | | | | | |
| Comparative | 18 | 2 | 4.4 | 0.16 | 27.7 |
| Example 3 | | | | | |
| Comparative | 22 | 3 | 6.5 | 0.36 | 18.3 |
| Example 3 | | | | | |
| Comparative | 18 | 4 | 6.0 | 0.32 | 18.7 |
| Example 3 | | | | | |
| Comparative | 32 | 5 | 9.7 | 0.46 | 21.3 |
| Example 3 | | | | | |
| Comparative | 9 | 1 | 3.0 | 0.08 | 36.4 |
| Example 4 | | | | | |

TABLE 4
Average Permeation Testing Results

| | | | | | Propylene | Propane | Propylene to |
|---|---|---|---|---|---|---|---|
| | | | | | Permeance | Permeance | Propane |
| Example | Caustic | Pretreatment | Tension | Pyrolysis | [GPU] | [GPU] | Selectivity |
| Inventive | 20 wt. % NaOH | 140° C. (24 hr) | 0.3 MPa, 40 | In 0.025″ | 6.3 | 0.2 | 31.3 |
| Example 1 | solution, 5 min dip | | fibers, 20 g | alumina | | | |
| | | | weight | tube | | | |
| Inventive | 45 wt. % KOH, | 140° C. (24 hr) | 0.17 MPa, | In 0.025″ | 10.75 | 0.66 | 17.4 |
| Example 2 | methanol, | then 200° C. | 100 fibers, | alumina | | | |
| | tetrahydrofuran, 10 | (12 hr) | 28 g weight | tube | | | |
| | min dip | | | | | | |
| Inventive | 45 wt. % KOH, | 140° C. (24 hr) | 0.06 MPa, | Bundle | 4.1 | 0.085 | 51.2 |
| Example 3 | methanol, | then 170° C. | 200 fibers, | pyrolysis | | | |
| | tetrahydrofuran, 10 | (12 hr) | 20 g weight | | | | |
| | min dip | | | | | | |
| Comparative | None | 140° C. (24 hr) | None, 100 | In 0.025″ | 8.0 | 0.35 | 23.3 |
| Example 3 | | (in 0.025″ | fibers | alumina | | | |
| | | alumina tube) | | tube | | | |
| Comparative | 45 wt. % KOH, | 140° C. (24 hr) | None, 200 | In 0.025″ | 3.0 | 0.08 | 36.4 |
| Example 4 | methanol, | (in 0.025″ | fibers | alumina | | | |
| | tetrahydrofuran, 10 | alumina tube) | | tube | | | |
| | min dip | | | | | | |

As shown above in Tables 3 and 4, the Examples showed high selectivity's for the preferential separation of propylene from propane, which indicates their usefulness in commercial applications for the separation of olefins from paraffins. While the Comparative Examples also showed selectivity for the separation of propylene and propane, the methods used to fabricate these examples are not suitable for commercial application due to the complicated nature of their fabrication. That is, each hollow fiber must be manually and individually threaded into alumina tubes to prevent sintering and fuzzing. When considering that CMS membrane may include from 1,000 to 10,000 individual fibers in operation, and that multiple CMS membranes may potentially be used in proximity in commercial application, this is an untenable solution.

Further, the Examples above also tend to show that treating the fibers with the KOH/non-aqueous solution and pretreating the hollow fibers at 140° C. to 170° C. created hollow fibers with even greater selectivity's than all other Examples. It is contemplated that the KOH/non-aqueous solution enhances these results because the non-aqueous solution may better coat all surfaces of the individual hollow fibers than just an aqueous solution. It is further contemplated that the organic solvent may help plasticize and swell the polymer chains of the pre-treatment hollow fibers, thereby allowing the caustic to diffuse into the fiber wall more easily and achieve a faster reaction time. It is additionally contemplated that the pretreatment temperatures of 140° C. to 170° C. also enhanced these results by avoiding the peak melting temperature of the PVDC copolymer, which occurs above approximately 170° C. Accordingly, operating just below 170° C. may minimize the localized melting of the PVDC copolymer.

According to a first aspect, a method of manufacturing a carbon molecular sieve (CMS) membrane includes forming one or more hollow fibers, the one or more hollow fibers including a polyvinylidene chloride copolymer; exposing the one or more hollow fibers to a caustic solution, wherein the caustic solution includes a strong base and a solvent; applying a tension at opposite ends of the one or more hollow fibers, thereby maintaining the one or more hollow fibers in a straight shape; pretreating the one or more hollow fibers under the tension by heating at a first temperature of from 120° C. to 200° C. with air, an inert gas, or combinations thereof; pyrolyzing the one or more hollow fibers at a second temperature of from 500° C. to 1500° C. with inert gas; and bundling the one or more hollow fibers to form the CMS membrane.

Another aspect includes any preceding aspect, wherein the tension is applied on opposite ends of the one or more hollow fibers contemporaneously with exposing the one or more hollow fibers to the caustic solution, pyrolyzing the one or more hollow fibers, or both.

Another aspect includes any preceding aspect, wherein the tension is from 0.2 MPa to 2 MPa.

Another aspect includes any preceding aspect, wherein the method further includes: subjecting the one or more hollow fibers to at least one water bath after exposing the one or more hollow fibers to the caustic solution, thereby removing the caustic solution from the one or more hollow fibers; drying the one or more hollow fibers before pretreating the one or more hollow fibers under the tension; or both.

Another aspect includes any preceding aspect, wherein pretreating the one or more hollow fibers under the tension further includes contacting the one or more hollow fibers with the air, the inert gas, or combinations thereof; pyrolyzing the one or more hollow fibers further includes contacting the one or more hollow fibers with the inert gas; and the inert gas includes carbon dioxide, nitrogen, or both.

Another aspect includes any preceding aspect, wherein the polyvinylidene chloride copolymer includes vinylidene chloride and at least one of the following comonomers: a vinyl monomer, a vinyl chloride monomer, an acrylate monomer, a methacrylate monomer, a styrenic monomer, acrylonitrile, methacrylonitrile, itaconic acid, and pyrolyzed chlorotrifluoroethylene.

Another aspect includes any preceding aspect, wherein the strong base includes lithium hydroxide, sodium hydroxide, potassium hydroxide, rubidium hydroxide, cesium hydroxide, calcium hydroxide, strontium hydroxide, or combinations thereof; and the solvent includes an aqueous solution or a non-aqeuous solution, the non-aqueous solution comprising tetrahydrofuran, alcohols, dimethylformamide, dimethyl sulfoxide, or combinations thereof.

Another aspect includes any preceding aspect, wherein each of the one or more hollow fibers include an inner diameter, an outer diameter, and a thickness between the inner diameter and the outer diameter; the outer diameter is from 50 microns to 5000 microns; and the thickness is from 10 microns to 100 microns.

Another aspect includes any preceding aspect, wherein the CMS membrane has a propylene permeance of from 2 to 12 Gas Permeation Units (GPU); a propane permeance of from 0.05 to 0.8 GPUs; and a propylene/propane selectivity of from 12 to 54.

A tenth aspect includes any preceding aspect, and further includes a method for separating gases from a gas mixture, the gas mixture comprising first gas molecules and second gas molecules, and wherein the method includes: forming the CMS membrane according to any previous aspect; and flowing the gas mixture through the CMS membrane to produce a permeate first stream having an increased concentration of the first gas molecules and a second retentate stream having an increased concentration of the second gas molecules, wherein the first gas molecules have a lesser representative molecular diameter than the second gas molecules.

An eleventh aspect includes the tenth aspect, wherein the CMS membrane has an average pore size greater than the representative molecular diameter of the second gas molecules as determined by gas adsorption employing gas probe molecules of differing sizes.

A twelfth aspect includes either the tenth or eleventh aspects, wherein the CMS membrane has an average pore size of greater than 3 angstroms.

A thirteenth aspect includes any one of the tenth through twelfth aspects, wherein the first gas molecules include olefins; and the second gas molecules include paraffins.

A fourteenth aspect includes any one of the tenth through thirteenth aspects, wherein the CMS membrane has a propylene permeance of from 2 to 12 Gas Permeation Units (GPU), a propane permeance of from 0.05 to 0.8 GPUs, and a propylene/propane selectivity of from 12 to 54; the first gas molecules include propylene; and the second gas molecules include propane.

A fifteenth aspect includes any one of the tenth through twelfth aspects, wherein the first gas molecules include at least one of hydrogen, ethylene, propylene, or butylene; and the second gas molecules include at least one of carbon dioxide, nitrogen, carbon monoxide, methane, ethane, propane, or butane.

It is noted that recitations in the present disclosure of a component of the present disclosure being “operable” or “sufficient” in a particular way, to embody a particular property, or to function in a particular manner, are structural recitations, as opposed to recitations of intended use. More specifically, the references in the present disclosure to the manner in which a component is “operable” or “sufficient” denotes an existing physical condition of the component and, as such, is to be taken as a definite recitation of the structural characteristics of the component.

The singular forms “a,” “an” and “the” include plural referents, unless the context clearly dictates otherwise.

Throughout this disclosure ranges are provided. It is envisioned that each discrete value encompassed by the ranges are also included. Additionally, the ranges which may be formed by each discrete value encompassed by the explicitly disclosed ranges are equally envisioned.

As used in this disclosure and in the appended claims, the words “comprise,” “has,” and “include” and all grammatical variations thereof are each intended to have an open, non-limiting meaning that does not exclude additional elements or steps.

As used in this disclosure, terms such as “first” and “second” are arbitrarily assigned and are merely intended to differentiate between two or more instances or components. It is to be understood that the words “first” and “second” serve no other purpose and are not part of the name or description of the component, nor do they necessarily define a relative location, position, or order of the component. Furthermore, it is to be understood that the mere use of the term “first” and “second” does not require that there be any “third” component, although that possibility is contemplated under the scope of the present disclosure.

Having described the subject matter of the present disclosure in detail and by reference to specific embodiments, it is noted that the various details disclosed in the present disclosure should not be taken to imply that these details relate to elements that are essential components of the various embodiments described in the present disclosure. Further, it will be apparent that modifications and variations are possible without departing from the scope of the present disclosure, including, but not limited to, embodiments defined in the appended claims.

1. A method of manufacturing a carbon molecular sieve (CMS) membrane, the method comprising:
forming a plurality of hollow fibers, the plurality of hollow fibers comprising a polyvinylidene chloride copolymer;
exposing the plurality of hollow fibers to a caustic solution, wherein the caustic solution comprises a strong base and a solvent;
applying a tension at opposite ends of the plurality of hollow fibers, thereby maintaining the plurality of hollow fibers in a straight shape;
pretreating the plurality of hollow fibers under the tension by heating at a first temperature of from 120° C. to 200° C. with air, an inert gas, or combinations thereof;
pyrolyzing the plurality of hollow fibers at a second temperature of from 500° C. to 1500° C. with inert gas; and
bundling the plurality of hollow fibers to form the CMS membrane.

2. The method of claim 1, wherein the tension is applied on opposite ends of the plurality of hollow fibers contemporaneously with exposing the plurality of hollow fibers to the caustic solution, pyrolyzing the plurality of hollow fibers, or both.

3. The method of claim 1, wherein the tension is from 0.2 MPa to 2 MPa.

4. The method of claim 1, further comprising:
subjecting the plurality of hollow fibers to at least one water bath after exposing the plurality of hollow fibers to the caustic solution, thereby removing the caustic solution from the plurality of hollow fibers;
drying the plurality of hollow fibers before pretreating the plurality of hollow fibers under the tension; or
both.

5. The method of claim 1, wherein:
pretreating the plurality of hollow fibers under the tension further comprises contacting the plurality of hollow fibers with the air, the inert gas, or combinations thereof;
pyrolyzing the plurality of hollow fibers further comprises contacting the plurality of hollow fibers with the inert gas; and
the inert gas comprises carbon dioxide, nitrogen, or both.

6. The method of claim 1, wherein the polyvinylidene chloride copolymer comprises vinylidene chloride and at least one of the following comonomers: a vinyl monomer, a vinyl chloride monomer, an acrylate monomer, a methacrylate monomer, a styrenic monomer, acrylonitrile, methacrylonitrile, itaconic acid, and or pyrolyzed chlorotrifluoroethylene.

7. The method of claim 1, wherein:
the strong base comprises lithium hydroxide, sodium hydroxide, potassium hydroxide, rubidium hydroxide, cesium hydroxide, calcium hydroxide, strontium hydroxide, organic amines or combinations thereof; and
the solvent comprises an aqueous solution or a non-aqeuous solution, the non-aqueous solution comprising tetrahydrofuran, alcohols, dimethylformamide, dimethyl sulfoxide, or combinations thereof.

8. The method of claim 1, wherein:
each of the plurality of hollow fibers comprises an inner diameter, an outer diameter, and a thickness between the inner diameter and the outer diameter;
the outer diameter is from 50 microns to 5000 microns; and
the thickness is from 10 microns to 100 microns.

9. The method of claim 1, wherein the CMS membrane has:
a propylene permeance of from 2 to 12 Gas Permeation Units (GPU);
a propane permeance of from 0.05 to 0.8 GPUs; and
a propylene/propane selectivity of from 12 to 54.

10. A process for separating gases from a gas mixture, the gas mixture comprising first gas molecules and second gas molecules, the method comprising:
forming the CMS membrane according to claim 1; and
flowing the gas mixture through the CMS membrane to produce a permeate first stream having an increased concentration of the first gas molecules and a second retentate stream having an increased concentration of the second gas molecules, wherein the first gas molecules have a lesser representative molecular diameter than the second gas molecules.

11. The process of claim 10, wherein the CMS membrane has an average pore size greater than the representative molecular diameter of the second gas molecules as determined by gas adsorption employing gas probe molecules of differing sizes.

12. The process of claim 10, wherein the CMS membrane has an average pore size of greater than 3 angstroms.

13. The process of claim 10, wherein:
the first gas molecules are comprised of olefins; and
the second gas molecules are comprised of paraffins.

14. The process of claim 10, wherein
the CMS membrane has a propylene permeance of from 2 to 12 Gas Permeation Units (GPU), a propane permeance of from 0.05 to 0.8 GPUs, and a propylene/propane selectivity of from 12 to 54;
the first gas molecules are comprised of propylene; and
the second gas molecules are comprised of propane.

15. The process of claim 10, wherein
the first gas molecules are comprised of at least one of hydrogen, ethylene, propylene, or butylene; and
the second gas molecules are comprised of at least one of carbon dioxide, nitrogen, carbon monoxide, methane, ethane, propane, or butane.
